(19) United States
(12) Patent Application Publication
(10) Pub. No.: US 2020/0269191 A1
(43) Pub. Date: Aug. 27, 2020

(54) PROCESS FOR PREPARATION OF A POROUS MEMBRANE FROM AT LEAST ONE THERMOPLASTIC POLYMER AND AT LEAST ONE WATER SOLUBLE POLYMER

(71) Applicant: BASF SE, Ludwigshafen am Rhein (DE)

(72) Inventors: Frank PRISSOK, Lemfoerde (DE); Raymond A NEFF, Wyandotte, MI (US); Juergen AHLERS, Ludwigshafen am Rhein (DE); Martin WEBER, Ludwigshafen am Rhein (DE); Oliver GRONWALD, Ludwigshafen am Rhein (DE)

(73) Assignee: BASF SE, Ludwigshafen am Rhein (DE)

(21) Appl. No.: 16/646,417

(22) PCT Filed: Oct. 8, 2018
(86) PCT No.: PCT/EP2018/077297

§ 371 Date: Mar. 11, 2020

(30) Foreign Application Priority Data
Oct. 10, 2017 (EP) 17195799.6

(51) Int. Cl. B01D 67/00; C08J 5/18; C08J 9/26; B01D 71/54; B01D 69/02; B01D 71/52

(52) U.S. Cl. CPC B01D 67/003; B01D 2325/04; C08J 9/26; B01D 71/54; B01D 69/02; B01D 71/52; C08J 2201/0464; C08J 2205/044; C08J 2375/04; C08J 2367/00; C08J 2377/00; C08J 2377/12; C08J 2325/06; C08J 2323/08; C08J 2329/14; B01D 2325/24; C08J 5/18

(57) ABSTRACT

A process for preparing a porous membrane containing a thermoplastic polymer, the process containing: (i) forming a film shaped compound containing the thermoplastic polymer and a water soluble polymer; and (ii) extracting the film shaped compound with a solvent mixture, thereby obtaining the porous membrane; wherein the thermoplastic polymer has pores with an average pore diameter <2000 nm, determined using Hg porosimetry according to DIN 66133, the thermoplastic polymer contains a polyurethane, wherein the polyurethane contains: −11 to 79% by weight of a mixture of a diol and a diisocyanate; and 21 to 89% by weight of the compound with two functional groups which are reactive towards isocyanate groups.

The present invention relates a process for preparation of a porous membrane comprising a thermoplastic polymer having pores with an average pore diameter <2000 nm, determined using Hg porosimetry according to DIN 66133, comprising: forming a film shaped compound of at least one thermoplastic polymer (TP1) and at least one water soluble polymer (WSP1); and extracting the film shaped compound obtained according to (i) with a solvent mixture (L1) obtaining the porous membrane.

Membranes for different purposes are known from the state of the art. Membranes are in particular used for separation purposes. For many applications, high water resistance is needed in combination with vapor permeability.

Membranes formed by phase inversion of polymer solutions are widely used in water filtration. According to the state of the art, a membrane may for example be produced by subjecting a backing fabric to phase inversion by casting a polymer solution onto the fabric to produce a coated fabric, introducing the coated fabric to a coagulation bath, and thereafter subjecting the coated fabric to annealing.

For the preparation of thin, semi-permeable membranes dry and wet manufacturing processes are currently used. Expanded PTFE (ePTFE) membranes are being prepared by an extrusion process of highly crystalline PTFE pellets with subsequent uni- or bidirectional stretching. As result, the process produces micro-porous membranes with nodes interconnected by small fibrils. For example, U.S. Pat. No. 3,962,153 relates to a porous ePTFE product consisting essentially of polytetrafluoroethylene produced by a process wherein an unsintered extrudate of said polymer is stretched. The stretched tetrafluoroethylene polymer has a porous form with an amorphous content and a micro-structure characterized by nodes interconnected by fibrils. U.S. Pat. No. 3,953,566 relates to the respective preparation process.

However, due to environmental reasons the replacement of ePTFE membranes with non-halogenated substitutes is under investigation. Thus, as alternative TPU membranes are being manufactured by the means of a wet process comprising the coagulation of polymer solutions with inorganic fillers as pore former. These porous layers are very thick (>0.5 mm) or have to be manufactured directly on textile layers as support material.

It was therefore an object of the invention to avoid the abovementioned disadvantages. In particular, it was an object to develop a process and a material for mechanically stable, semi-permeable, non-halogenated porous membranes.

According to the present invention, this object is solved by a process for preparation of a porous membrane comprising a thermoplastic polymer having pores with an average pore diameter <2000 nm, determined using Hg porosimetry according to DIN 66133, comprising:
(i) forming a film shaped compound of at least one thermoplastic polymer (TP1) and at least one water soluble polymer (WSP1);
(ii) extracting the film shaped compound obtained according to (i) with a solvent mixture (L1) obtaining the porous membrane.

Surprisingly, it was found that a porous membrane produced according to this process has significantly improved water vapor permeability after extraction of the soluble polymer.

In the context of this application a membrane shall be understood to be a thin, semipermeable structure capable of separating two fluids or separating molecular and/or ionic components or particles from a liquid. A membrane acts as a selective barrier, allowing some particles, substances or chemicals to pass through, while retaining others. For example, membranes can be reverse osmosis (RO) membranes, forward osmosis (FO) membranes, nanofiltration (NF) membranes, ultrafiltration (UF) membranes or microfiltration (MF) membranes.

In step (i), a film shaped compound is formed at least one thermoplastic polymer (TP1) and at least one water soluble polymer (WSP1). According to an embodiment of the process, the water-soluble polymer (WSP1) has a solubility in water of >50 g/l, preferably of >150 g/l, more preferably of >200 g/l, more preferably of >250 g/l. According to a preferred embodiment, the at least one water soluble polymer (WSP1) is selected from the group consisting of polyethylene oxide, polyvinylpyrrolidone and mixtures of these polymers and comprises preferably at least polyvinylpyrrolidone. Polyvinylpyrolidone has preferably a number average molecular weight Mₙ in the range of from 1 to 3000 kg/mol, more preferably in the range of from 10 to 2500 kg/mol, more preferably in the range of from 20 to 2000 kg/mol, more preferably 40 to 1500 kg/mol. Polyethylene oxide has preferably a number average molecular weight Mₙ in the range of from 10 to 10,000 kg/mol, more preferably in the range of from 50 to 5,000 kg/mol, more preferably in the range of from 100 to 1,000 kg/mol, more preferably in the range of from 200 to 500 kg/mol.

In step (ii), the film shaped compound obtained according to (i) is extracted with a solvent mixture (L1) obtaining the porous membrane. According to a further embodiment of the process, the at least one water soluble polymer (WSP1) is added in (i) in an amount in the range of from 1 to 50% by weight, preferably in the range of from 5 to 45% by weight, more preferably in the range of from 10 to 40% by weight, based on the total weight of the mixture of the at least one thermoplastic polymer (TP1) and the at least one water soluble polymer (WSP1).

According to another embodiment of the process, the mixture (L1) comprises water, wherein L1 comprises preferably at least more than 50% by weight, more preferably at least 60% by weight, more preferably at least 80% by weight, more preferably at least 90% by weight, more preferably at least 95% by weight, more preferably at least 98% by weight water, based on the total weight of the mixture L1.

According to a further embodiment of the process, the extraction according to (ii) is carried out for at least 1 hour, preferably for a time in the range of from 1 hour to 10 days, more preferably in the range of from 10 hours to 200 hours. Preferably, the extraction according to (ii) is carried out at a temperature in the range of from 5 to 100° C., more preferably in the range of from 10 to 50° C., more preferably in the range of from 15 to 40° C.

According to step (ii), the film shaped compound obtained according to (i) is extracted with a solvent mixture (L1) obtaining the porous membrane. During said extraction, the at least one water soluble polymer (WSP1) is at least partially removed from the film shaped compound, thereby forming pores within the film shaped compound. Residues of the WSP1 may remain in the film shaped compound, for example, due to complete inclusion of parts of WSP1 within the at least one TP1. Preferably, less than 50% by weight, more preferably less than 20% by weight, more preferably less than 10% by weight, of the WSP1 based on the total weight of the WSP1 used in step (i) remain in the film shaped compound after extraction step (ii), i.e. in the obtained porous membrane. Thus, the porous membrane obtained in (ii) preferably comprises less than 50% by weight, more preferably less than 20% by weight, more preferably less than 10% by weight, of the WSP1 based on the total weight of the WSP1 used in step (i)

Thus, a preferred embodiment of the present invention relates to a process for preparation of a porous membrane comprising a thermoplastic polymer having pores with an average pore diameter <2000 nm, determined using Hg porosimetry according to DIN 66133 comprising:
(i) forming a film shaped compound of at least one thermoplastic polymer (TP1) and at least one water soluble polymer (WSP1);
(ii) extracting the film shaped compound obtained according to (i) with a solvent mixture (L1) thereby removing the at least one water soluble polymer at least partially from the film shaped compound, obtaining the porous membrane,
   wherein the obtained porous membrane preferably comprises less than 50% by weight, more preferably less than 20% by weight, more preferably less than 10% by weight, of the WSP1 based on the total weight of the WSP1 used in step (i).

According to one embodiment of the process, the at least one thermoplastic polymer (TP1) is selected from the group consisting of polyurethane, polyester, polyetherester, polyesterester, polyamide, polyetheramide, polystyrene and ethylene vinylacetate, preferably polyurethane (TPU).

According to a preferred embodiment of the process, the at least one thermoplastic polymer (TP1) comprises at least one polyurethane, wherein the polyurethane (PU1) is based on the following components:
11 to 79% by weight of a mixture of at least one diol (D1) and at least one polyisocyanate (I1);
21 to 89% by weight of at least one compound (C1) with at least two functional groups which are reactive towards isocyanate groups.

In the context of the present invention, the amount of the components on which the polyurethane is based adds up to 100% by weight. These components form the polymeric structure of the polyurethane. Additionally, the polyurethane may comprise further additives.

The at least one compound (C1) has at least two functional groups which are reactive towards isocyanate groups. Preferably, the at least one compound (C1) has two functional groups which are reactive towards isocyanate groups. Compound (C1) may be any compound with at least two functional groups, preferably two functional groups, which are reactive towards isocyanate groups. Preferably, the functional groups which are reactive towards isocyanate groups are hydroxyl or amino groups. Compound (C1) may be added to modify the properties of the polyurethane (PU1). Any compound can be used as long as it can be used to form a polyurethane (PU1) with the mixture of at least one diol (D1) and at least one polyisocyanate (I1). For example, compound (C1) may be a polyol, preferably a diol, but compound (C1) may also be a polymer with at least two hydroxyl groups or at least two amino groups other than a polyol, preferably two hydroxyl groups or two amino groups other than a polyol, for example a hydrophobic polymer or oligomer comprising silicon.

For the purposes of the present invention it is possible here to use any suitable polyol as compound (C1), preferably any suitable diol, for example polyether diols or polyester diols, or a mixture of two or more thereof.

Suitable polyether polyols or diols according to the present invention are for example polyether diols based on ethylene oxide or propylene oxide or mixtures thereof, for example copolymers such as blockcopolymers. Furthermore, the invention can use any suitable polyester diols, and for the purposes of the present invention the expression polyester diol also comprises polycarbonate diols.

According to a preferred embodiment, compound (C1) is a polyol, preferably a diol, more preferably selected from the group consisting of polyesterpolyol and polyetherpolyol, more preferably at least polytetrahydrofurane. Preferably, the compound (C1) is a diol, more preferably selected from the group consisting of polyesterdiol and polyetherdiol, more preferably at least polytetrahydrofurane.

According to a preferred embodiment, the at least one isocyanate (I1) is a diisocyanate. As the at least one isocyanate (I1), it is possible to use aliphatic, cycloaliphatic, araliphatic and/or aromatic diisocyanates. Specific examples include the following aromatic isocyanates: 2,4-toluene diisocyanate, mixtures of 2,4- and 2,6-toluene diisocyanate, 4,4′-, 2,4′- and/or 2,2′-diphenylmethane diisocyanate (MDI), mixtures of 2,4′- and 4,4′-diphenylmethane diisocyanate, urethane-modified liquid 4,4′- and/or 2,4-diphenylmethane diisocyanates, 4,4′-diisocyanatodiphenylethane, the mixtures of monomeric methanediphenyl diisocyanates and more highly polycyclic homologues of methanediphenyl diisocyanate (polymeric MDI), 1,2- and 1,5-naphthylene diisocyanate.

Aliphatic diisocyanates used are customarily aliphatic and/or cycloaliphatic diisocyanates, examples being tri-, tetra-, penta-, hexa-, hepta- and/or octamethylene diisocyanate, 2-methyl-pentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), dicyclohexyl methane-4,4′-diisocyanate (H12MDI), 1,4-cyclohexane diisocyanate, 1-methyl-2,4- and/or -2,6-cyclohexane diisocyanate, 4,4′-, 2,4′- and/or 2,2′-dicyclohexylmethane diisocyanate.

In accordance with the invention, the polyisocyanate, preferably the diisocyanate, can be used in pure form or in the form of a composition, for example, an isocyanate prepolymer. In a further embodiment, a mixture can be used which comprises polyisocyanate, preferably diisocyanate, and at least one solvent. Suitable solvents are known to the skilled person.

Polyisocyanate prepolymers are obtainable by reacting above-described polyisocyanates, preferably the above-described diisocyanates, in excess, at temperatures of 30 to 100° C., for example, preferably at about 80° C., with polyols to give the prepolymer. For the preparation of the prepolymers, preference is given to using polyisocyanates, preferably diisocyanates, and commercial polyols based on polyesters, starting for example from adipic acid, or on polyethers, starting for example from ethylene oxide and/or propylene oxide.

Polyols are known to the skilled person and are described for example in “Kunststoffhandbuch, volume 7, Polyurethane”, Carl Hanser Verlag, 3rd edition 1993, section 3.1. Polyols used with preference in this context are the polymeric compounds described with respect to (C1), having hydrogen atoms that are reactive toward isocyanates. Particularly preferred for use as polyols are polyetherpolyols.

In the preparation of the isocyanate prepolymers, customary chain extenders or crosslinking agents are added optionally to the stated polyols. Such substances are described with respect to D1 hereinafter. Particularly preferred for use as chain extender is 1,4-butanediol, ethane diol, hexane diole and/or monoethylene glycol In this case the ratio of organic polyisocyanates to polyols and chain extenders is preferably selected such that the isocyanate prepolymer has an NCO content of 2% to 30%, preferably of 6% to 28%, more preferably of 10% to 24%.

According to a preferred embodiment, the at least one isocyanate (I1) is a polyisocyanate, more preferably a diisocyanate, more preferably selected from the group consisting of diphenyl methane diisocyanate (MDI), toluenediisocyanate (TDI), hexamethylenediisocyanate (HDI) and dicyclohexyl methane-4,4′-diisocyanate (H12MDI), preferably at least MDI.

According to the present invention, at least one diol (D1) is used, which acts as chain extender. Generally, any diol can be used in the context of the present invention. Diol (D1) can preferably be selected from aliphatic, araliphatic, aromatic, and/or cycloaliphatic compounds with a molar mass of from 0.05 kg/mol to 0.499 kg/mol, preferably difunctional compounds, for example diamines and/or alkanediols having from 2 to 10 carbon atoms in the alkylene moiety, di-, tri-, tetra-, penta-, hexa-, hepta-, octa-, nona-, and/or decaalkylene glycols having from 3 to 8 carbon atoms, in particular ethylene 1,2-glycol, 1,3-propanediol, 1,4-butanediol, 1,6-hexanediol, and preferably corresponding oligo- and/or polypropylene glycols such as diethylene glycol, dipropylene glycol, 1,4-cyclohexanediol, 1,4-dimethanolcyclohexane, and neopentyl glycol, and it is also possible here to use a mixture of the chain extenders.

It is preferable that the diols used have only primary hydroxy groups, and very particular preference is given to the at least one diol (D1) being selected from the group consisting of ethane diol, butane diol, hexane diol and monoethylene glycol, preferably comprising at least 1,4-butane diol or monoethylene glycol.

According to a preferred embodiment of the process, the at least one thermoplastic polymer (TP1) comprises at least one polyurethane, wherein the polyurethane (PU1) is based on the following components:
11 to 79% by weight of a mixture of at least 1,4-butane diol or monoethylene glycol and at least MDI;
21 to 89% by weight of at least polytetrahydrofuran.

According to a further preferred embodiment, the process comprises:
(i) forming a film shaped compound of at least one thermoplastic polymer (TP1) and at least one water soluble polymer (WSP1);
(ii) extracting the film shaped compound obtained according to (i) with a solvent mixture (L1) thereby removing the at least one water soluble polymer at least partially from the film shaped compound, obtaining the porous membrane;
   wherein the at least one thermoplastic polymer (TP1) in comprises at least one polyurethane, wherein the polyurethane (PU1) is based on the following components:
11 to 79% by weight of a mixture of at least 1,4-butane diol or monoethylene glycol and at least MDI;
21 to 89% by weight of at least polytetrahydrofuran;
   and the at least one water soluble polymer (WSP1) comprises at least polyvinylpyrrolidone.

Preferably, the at least one thermoplastic polymer (TP1) consists of one thermoplastic polymer, preferably of one TPU.

According to the present invention, the polyurethane (PU1) may be prepared using further components such as for example catalysts, and/or conventional auxiliaries and/or of additives.

Conventional auxiliaries may be for example surfactant substances, fillers, further flame retardants, nucleating agents, oxidation stabilizers, lubricants and mold-release aids, dyes, and pigments, and optionally stabilizers, e.g. for protection from hydrolysis, light, heat, or discoloration, inorganic and/or organic fillers, reinforcing agents, and plasticizers. Suitable auxiliaries and additives can be found by way of example in Kunststoffhandbuch, volume 7, Polyurethane”, Carl Hanser Verlag, 1st edition 1966, pp. 103-113.

Preferably, the average pore diameter of the porous membrane is in the range of from 0.001 to 2 μm, more preferably in the range of from 0.001 μm to 1.5 μm, more preferably in the range of from 0.001 μm to 0.8 μm, determined using Hg porosimetry according to DIN 66133. The porous membrane has preferably an absolute water vapor permeability (WDD_{abs.}) at 38° C. and 90% relative humidity according to DIN 53122 >900 [g/m²*d]. Preferably, the porous membrane has a liquid entry pressure (LEP) >2 bar, more preferably in the range of from 2 to 6 bar, more preferably in the range of from 4 to 5 bar, determined according to DIN EN 20811.

According to a further embodiment, the present invention is also directed to a process as disclosed above, wherein (i) comprises:
(i.1) compounding at least one thermoplastic polymer (TP1) and at least one water soluble polymer (WSP1) at a temperature above the melting temperature of the at least one thermoplastic polymer;
(i.2) forming a film from the compound obtained according to (i.1) obtaining a film shaped compound.

According to a preferred embodiment, the present invention is also directed to a process as disclosed above, wherein the film forming according to (i.2) is carried out by extrusion.

According to a further embodiment, the present invention is also directed to a process as disclosed above further comprising:
(iii) drying the porous membrane obtained in (ii).

According to the process of the present invention, a porous membrane is obtained. The process of the present invention can also comprise further steps, for example washing steps or a temperature treatment.

The membrane obtained or obtainable according to the process of the present invention has an average thickness in the range of from 5 to 500 μm, preferably in the range of from 30 to 400 μm. According to a further embodiment, the porous membrane has a minimum thickness of 20 μm and a maximum thickness of 1000 μm, preferably a minimum thickness of 30 μm and a maxmimum thickness of 500 μm, more preferably a minimum thickness of 50 μm and a maximum thickness of 400 μm.

According to a further aspect, the present invention is also related to a porous membrane comprising a thermoplastic polymer having pores with an average pore diameter <2000 nm, determined using Hg porosimetry according to DIN 66133, obtained or obtainable by a process as disclosed above.

According to a further aspect, the present invention is also related to a porous membrane comprising a thermoplastic polymer (TP1) having pores with an average pore diameter <2000 nm, determined using Hg porosimetry according to DIN 66133. Preferably, the porous membrane comprising a thermoplastic polymer (TP1) having pores with an average pore diameter <2000 nm, determined using Hg porosimetry according to DIN 66133 is obtained or obtainable by
(i) forming a film shaped compound of at least one thermoplastic polymer (TP1) and at least one water soluble polymer (WSP1);
(ii) extracting the film shaped compound obtained according to (i) with a solvent mixture (L1) thereby removing the at least one water soluble polymer at least partially from the film shaped compound, obtaining the porous membrane.

As described above, the at least one thermoplastic polymer (TP1) is selected from the group consisting of polyurethane, polyester, polyetherester, polyesterester, polyamide, polyetheramide, polystyrene and ethylene vinylacetate, preferably polyurethane (TPU).

According to a preferred embodiment of the porous membrane, the at least one thermoplastic polymer (TP1) comprises at least one polyurethane, wherein the polyurethane (PU1) is based on the following components:
11 to 79% by weight of a mixture of at least one diol (D1) and at least one polyisocyanate (I1);
21 to 89% by weight of at least one compound (C1) with at least two functional groups which are reactive towards isocyanate groups.

According to a further preferred embodiment of the porous membrane, the at least one thermoplastic polymer (TP1) comprises at least one polyurethane, wherein the polyurethane (PU1) is based on the following components:
11 to 79% by weight of a mixture of at least one diol (D1) and at least one diisocyanate (I1);
21 to 89% by weight of at least one compound (C1) with two functional groups which are reactive towards isocyanate groups.

According to a further preferred embodiment, the porous membrane comprising a thermoplastic polymer (TP1) having pores with an average pore diameter <2000 nm, determined using Hg porosimetry according to DIN 66133, is obtained or obtainable by
(i) forming a film shaped compound of at least one thermoplastic polymer (TP1) and at least one water soluble polymer (WSP1);
(ii) extracting the film shaped compound obtained according to (i) with a solvent mixture (L1) thereby removing the at least one water soluble polymer at least partially from the film shaped compound, obtaining the porous membrane;
   wherein the at least one thermoplastic polymer (TP1) comprises at least one polyurethane, wherein the polyurethane (PU1) is based on the following components:
11 to 79% by weight of a mixture of at least one diol (D1) and at least one polyisocyanate (I1);
21 to 89% by weight of at least one compound (C1) with at least two functional groups which are reactive towards isocyanate groups.

According to a further preferred embodiment, the porous membrane comprising a thermoplastic polymer (TP1) having pores with an average pore diameter <2000 nm, determined using Hg porosimetry according to DIN 66133, is obtained or obtainable by
(i) forming a film shaped compound of at least one thermoplastic polymer (TP1) and at least one water soluble polymer (WSP1);
(ii) extracting the film shaped compound obtained according to (i) with a solvent mixture (L1) thereby removing the at least one water soluble polymer at least partially from the film shaped compound, obtaining the porous membrane;
   wherein the at least one thermoplastic polymer (TP1) comprises at least one polyurethane, wherein the polyurethane (PU1) is based on the following components:
11 to 79% by weight of a mixture of at least one diol (D1) and at least one diisocyanate (I1);
21 to 89% by weight of at least one compound (C1) with two functional groups which are reactive towards isocyanate groups.

According to a further aspect, the present invention relates to a porous membrane comprising a thermoplastic polymer (TP1) having pores with an average pore diameter <2000 nm, determined using Hg porosimetry according to DIN 66133, wherein the at least one thermoplastic polymer (TP1) comprises at least one polyurethane, wherein the polyurethane (PU1) is based on the following components:
11 to 79% by weight of a mixture of at least one diol (D1) and at least one polyisocyanate (I1);
21 to 89% by weight of at least one compound (C1) with at least two functional groups which are reactive towards isocyanate groups.

According to a further aspect, the present invention relates to a porous membrane comprising a thermoplastic polymer (TP1) having pores with an average pore diameter <2000 nm, determined using Hg porosimetry according to DIN 66133, wherein the at least one thermoplastic polymer (TP1) comprises at least one polyurethane, wherein the polyurethane (PU1) is based on the following components:
11 to 79% by weight of a mixture of at least one diol (D1) and at least one diisocyanate (I1);
21 to 89% by weight of at least one compound (C1) with two functional groups which are reactive towards isocyanate groups.

In the context of the present invention, the amount of the components on which the polyurethane is based adds up to 100% by weight. These components form the polymeric structure of the polyurethane. Additionally, the polyurethane may comprise further additives.

The at least one compound (C1) has at least two functional groups which are reactive towards isocyanate groups. Preferably, the at least one compound (C1) has two functional groups which are reactive towards isocyanate groups. Compound (C1) may be any compound with at least two functional groups, preferably two functional groups, which are reactive towards isocyanate groups. Preferably, the functional groups which are reactive towards isocyanate groups are hydroxyl or amino groups. Compound (C1) may be added to modify the properties of the polyurethane (PU1). Any compound can be used as long as it can be used to form a polyurethane (PU1) with the mixture of at least one diol (D1) and at least one polyisocyanate (I1). For example, compound (C1) may be a polyol, preferably a diol, but compound (C1) may also be a polymer with at least two hydroxyl groups or at least two amino groups other than a polyol, preferably with two hydroxyl groups or two amino groups other than a polyol, for example a hydrophobic polymer or oligomer comprising silicon.

For the purposes of the present invention it is possible here to use any suitable polyol as compound (C1), for example polyether diols or polyester diols, or a mixture of two or more thereof.

Suitable polyether polyols or diols according to the present invention are for example polyether diols based on ethylene oxide or propylene oxide or mixtures thereof, for example copolymers such as blockcopolymers. Furthermore, the invention can use any suitable polyester diols, and for the purposes of the present invention the expression polyester diol also comprises polycarbonate diols.

According to a preferred embodiment, compound (C1) is a polyol, preferably a diol, more preferably selected from the group consisting of polyesterpolyol and polyetherpolyol, more preferably at least polytetrahydrofurane. Preferably, compound (C1) is a diol, more preferably selected from the group consisting of polyesterdiol and polyetherdiol, more preferably at least polytetrahydrofurane.

The at least one isocyanate (I1) is preferably a diisocyanate. As the at least one isocyanate (I1), it is possible to use aliphatic, cycloaliphatic, araliphatic and/or aromatic diisocyanates. Specific examples include the following aromatic isocyanates: 2,4-toluene diisocyanate, mixtures of 2,4-and 2,6-toluene diisocyanate, 4,4′-, 2,4′- and/or 2,2′-diphenylmethane diisocyanate (MDI), mixtures of 2,4′- and 4,4′-diphenylmethane diisocyanate, urethane-modified liquid 4,4′- and/or 2,4-diphenylmethane diisocyanates, 4,4′-diisocyanatodiphenylethane, the mixtures of monomeric methanediphenyl diisocyanates and more highly polycyclic homologues of methanediphenyl diisocyanate (polymeric MDI), 1,2- and 1,5-naphthylene diisocyanate.

Aliphatic diisocyanates used are customarily aliphatic and/or cycloaliphatic diisocyanates, examples being tri-, tetra-, penta-, hexa-, hepta- and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), dicyclohexyl methane-4,4′-diisocyanate (H12MDI), 1,4-cyclohexane diisocyanate, 1-methyl-2,4- and/or -2,6-cyclohexane diisocyanate, 4,4′-, 2,4′- and/or 2,2′-dicyclohexylmethane diisocyanate.

In accordance with the invention, the polyisocyanate, preferably the diisocyanate, can be used in pure form or in the form of a composition, for example, an isocyanate prepolymer. In a further embodiment, a mixture can be used which comprises polyisocyanate, preferably diisocyanate, and at least one solvent. Suitable solvents are known to the skilled person.

Polyisocyanate prepolymers are obtainable by reacting above-described polyisocyanates, preferably the above-described diisocyanates, in excess, at temperatures of 30 to 100° C., for example, preferably at about 80° C., with polyols to give the prepolymer. For the preparation of the prepolymers, preference is given to using polyisocyanates, preferably diisocyanates, and commercial polyols based on polyesters, starting for example from adipic acid, or on polyethers, starting for example from ethylene oxide and/or propylene oxide.

Polyols are known to the skilled person and are described for example in “Kunststoffhandbuch, volume 7, Polyurethane”, Carl Hanser Verlag, 3rd edition 1993, section 3.1. Polyols used with preference in this context are the polymeric compounds described under b), having hydrogen atoms that are reactive toward isocyanates. Particularly preferred for use as polyols are polyetherpolyols.

In the preparation of the isocyanate prepolymers, customary chain extenders or crosslinking agents are added optionally to the stated polyols. Such substances are described with respect to C1 hereinafter. Particularly preferred for use as chain extender is 1,4-butanediol, ethane diol, hexane diol and/or monoethylene glycol. In this case the ratio of organic polyisocyanates to polyols and chain extenders is preferably selected such that the isocyanate prepolymer has an NCO content of 2% to 30%, preferably of 6% to 28%, more preferably of 10% to 24%.

According to a preferred embodiment, the at least one isocyanate (I1) is a polyisocyanate, preferably a diisocyanate, more preferably selected from the group consisting of diphenyl methane diisocyanate (MDI), toluenediisocyanate (TDI), hexamethylenediisocyanate (HDI) and dicyclohexyl methane-4,4′-diisocyanate (H12MDI), preferably at least MDI.

According to the present invention, at least one diol (D1) is used, which acts as chain extender. Generally, any diol can be used in the context of the present invention. Diol (D1) can preferably be selected from aliphatic, araliphatic, aromatic, and/or cycloaliphatic compounds with a molar mass of from 0.05 kg/mol to 0.499 kg/mol, preferably difunctional compounds, for example diamines and/or alkanediols having from 2 to 10 carbon atoms in the alkylene moiety, di-, tri-, tetra-, penta-, hexa-, hepta-, octa-, nona-, and/or decaalkylene glycols having from 3 to 8 carbon atoms, in particular ethylene 1,2-glycol, 1,3-propanediol, 1,4-butanediol, 1,6-hexanediol, and preferably corresponding oligo- and/or polypropylene glycols such as diethylene glycol, dipropylene glycol, 1,4-cyclohexanediol, 1,4-dimethanolcyclohexane, and neopentyl glycol, and it is also possible here to use a mixture of the chain extenders.

It is preferable that the diols used have only primary hydroxy groups, and very particular preference is given to the at least one diol (D1) being selected from the group consisting of ethane diol, butane diol, hexane diol and monoethylene glycol, preferably comprising at least 1,4-butane diol or monoethylene glycol.

According to a preferred embodiment, the at least one thermoplastic polymer (TP1) comprises at least one polyurethane, wherein the polyurethane (PU1) is based on the following components:
11 to 79% by weight of a mixture of at least 1,4-butane diol or monoethylene glycol and at least MDI;
21 to 89% by weight of at least polytetrahydrofuran.

Preferably, the at least one thermoplastic polymer (TP1) consists of one thermoplastic polymer, preferably of one TPU.

According to the present invention, the polyurethane (PU1) may be prepared using further components such as for example catalysts, and/or conventional auxiliaries and/or of additives.

Conventional auxiliaries may be for example surfactant substances, fillers, further flame retardants, nucleating agents, oxidation stabilizers, lubricants and mold-release aids, dyes, and pigments, and optionally stabilizers, e.g. for protection from hydrolysis, light, heat, or discoloration, inorganic and/or organic fillers, reinforcing agents, and plasticizers. Suitable auxiliaries and additives can be found by way of example in Kunststoffhandbuch, volume 7, Polyurethane”, Carl Hanser Verlag, 1st edition 1966, pp. 103-113.

Since the porous membrane is prepared by extracting at least one water soluble polymer (WSP1) from a film shaped compound, it may be that the at least one water soluble polymer (WSP1) is only partially removed from the film shaped compound, thereby forming pores within the film shaped compound. Residues of the WSP1 may remain in the film shaped compound, for example, due to complete inclusion within the at least one TP1. Preferably, less than 50% by weight, more preferably less than 20% by weight, more preferably less than 10% by weight, of the WSP1 based on the total weight of the WSP1 used in step (i) remain in the film shaped compound after extraction step (ii), i.e. in the obtained porous membrane. Thus, the porous membrane may comprise in one embodiment 0.49 to 24.9% by weight, preferably 2.49 to 22.49% by weight, more preferably 4.9 to 19.9% by weight of at least one water soluble polymer (WSP1) based in the total weight of the porous membrane.

Thus, according to a further embodiment, the porous membrane comprising a thermoplastic polymer (TP1) having pores with an average pore diameter <2000 nm, determined using Hg porosimetry according to DIN 66133, wherein the at least one thermoplastic polymer (TP1) comprises at least one polyurethane, wherein the polyurethane (PU1) is based on the following components:
11 to 79% by weight of a mixture of at least one diol (D1) and at least one polyisocyanate (I1);
21 to 89% by weight of at least one compound (C1) with at least two functional groups which are reactive towards isocyanate groups;
   wherein the porous membrane comprises 0.49 to 24.9% by weight, preferably 2.49 to 22.49% by weight, more preferably 4.9 to 19.9% by weight of at least one water soluble polymer (WSP1) based on the total weight of the porous membrane.

According to a further embodiment, the porous membrane comprising a thermoplastic polymer (TP1) having pores with an average pore diameter <2000 nm, determined using Hg porosimetry according to DIN 66133, wherein the at least one thermoplastic polymer (TP1) comprises at least one polyurethane, wherein the polyurethane (PU1) is based on the following components:
11 to 79% by weight of a mixture of at least one diol (D1) and at least one diisocyanate (I1);
21 to 89% by weight of at least one compound (C1) with two functional groups which are reactive towards isocyanate groups;
   wherein the porous membrane comprises 0.49 to 24.9% by weight, preferably 2.49 to 22.49% by weight, more preferably 4.9 to 19.9% by weight of at least one water soluble polymer (WSP1) based on the total weight of the porous membrane.

The water-soluble polymer (WSP1) is a polymer having a solubility in water of >50 g/l, preferably of >150 g/l, more preferably of >200 g/l, more preferably of >250 g/l. According to a preferred embodiment, the at least one water soluble polymer (WSP1) is selected from the group consisting of polyethylene oxide, polyvinylpyrrolidone and mixtures of these polymers and comprises preferably at least polyvinylpyrrolidone. Polyvinylpyrolidone has preferably a number average molecular weight Mₙ in the range of from 1 to 3000 kg/mol, more preferably in the range of from 10 to 2500 kg/mol, more preferably in the range of from 20 to 2000 kg/mol, more preferably 40 to 1500 kg/mol. Polyethylene oxide has preferably a number average molecular weight Mₙ in the range of from 10 to 10,000 kg/mol, more preferably in the range of from 50 to 5,000 kg/mol, more preferably in the range of from 100 to 1,000 kg/mol, more preferably in the range of from 200 to 500 kg/mol.

Preferably, the average pore diameter of the porous membrane is in the range of from 0.001 to 2 μm, more preferably in the range of from 0.001 μm to 1.5 μm, more preferably in the range of from 0.001 μm to 0.8 μm, determined using Hg porosimetry according to DIN 66133. The porous membrane has preferably an absolute water vapor permeability (WDD_{abs}.) at 38° C. and 90% relative humidity according to DIN 53122 >900 [g/m²*d]. Preferably, the porous membrane has a liquid entry pressure (LEP) >2 bar, more preferably in the range of from 2 to 6 bar, more preferably in the range of from 4 to 5 bar, determined according to DIN EN 20811.

The membrane obtained or obtainable according to the process of the present invention has an average thickness in the range of from 5 to 500 μm, preferably in the range of from 30 to 400 μm. According to a further embodiment, the porous membrane has a minimum thickness of 20 μm and a maximum thickness of 1000 μm, preferably a minimum thickness of 30 μm and a maxmimum thickness of 500 μm, more preferably a minimum thickness of 50 μm and a maximum thickness of 400 μm.

According to a further aspect, the present invention is also directed to the use of the porous membrane obtained or obtainable according to the process as disclosed above or of the porous membrane as disclosed above for coating a woven surface of an article.

According to a further aspect, the present invention is also directed to the use of the porous membrane obtained or obtainable according to the process as disclosed above or of the porous membrane as disclosed above for an article having no woven layer.

The porous membranes a can be used for example for functional clothing, functional foot wear and functional article, preferably selected from the group consisting of jacket, trouser, shoe, boot, protective suit, tent, tarpaulin, backpack and umbrella.

According to a further aspect, the present invention is also directed to an article comprising the porous membrane obtained or obtainable according to the process as disclosed above or of the porous membrane as disclosed above.

The present invention is further illustrated by the following embodiments and combinations of embodiments as indicated by the respective dependencies and back-references. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”.
1. Process for preparation of a porous membrane comprising a thermoplastic polymer having pores with an average pore diameter <2000 nm, determined using Hg porosimetry according to DIN 66133 comprising:
   (i) forming a film shaped compound of at least one thermoplastic polymer (TP1) and at least one water soluble polymer (WSP1);
   (ii) extracting the film shaped compound obtained according to (i) with a solvent mixture (L1) obtaining the porous membrane.
2. The process according to embodiment 1, wherein the water-soluble polymer (WSP1) has a solubility in water of >50 g/l, preferably of >150 g/l, more preferably of >200 g/l, more preferably of >250 g/l.
3. The process according to embodiment 1 or 2, wherein the at least one water soluble polymer (WSP1) is selected from the group consisting of polyethylene oxide, polyvinylpyrrolidone and mixtures of these polymers and comprises preferably at least polyvinylpyrrolidone.
4. The process according to any one of embodiments 1 to 3, wherein in (i) the at least one water soluble polymer is added in an amount in the range of from 1 to 50% by weight, preferably in the range of from 5 to 45% by weight, more preferably in the range of from 10 to 40% by weight, based on the total weight of the mixture of the at least one thermoplastic polymer (TP1) and the at least one water soluble polymer (WSP1).
5. The process according any one of embodiments 1 to 4, wherein the mixture (L1) comprises water, wherein L1 comprises preferably at least more than 50% by weight, more preferably at least 60% by weight, more preferably at least 80% by weight, more preferably at least 90% by weight, more preferably at least 95% by weight, more preferably at least 98% by weight water, based on the total weight of the mixture L1.
6. The process according any one of embodiments 1 to 5, wherein the extraction according to (ii) is carried out for at least 1 hour, preferably for a time in the range of from 1 hour to 10 days, more preferably in the range of from 10 hours to 200 hours.
7. The process according any one of embodiments 1 to 6, wherein the extraction according to (ii) is carried out at a temperature in the range of from 5 to 100° C., preferably in the range of from 10 to 50° C., more preferably in the range of from 15 to 40° C.
8. The process according to any one of embodiments 1 to 7, wherein the at least one thermoplastic polymer (TP1) is selected from the group consisting of polyurethane, polyester, polyetherester, polyesterester, polyamide, polyetheramide, polystyrene and ethylene vinylacetate, preferably polyurethane (TPU).
9. The process according to any one of embodiments 1 to 8, wherein the at least one thermoplastic polymer (TP1) comprises at least one polyurethane, wherein the polyurethane (PU1) is based on the following components:
   11 to 79% by weight of a mixture of at least one diol (D1) and at least one polyisocyanate (I1);
   21 to 89% by weight of at least one compound (C1) with at least two functional groups which are reactive towards isocyanate groups.
10. The process according to any one of embodiments 1 to 9, wherein the at least one thermoplastic polymer (TP1) comprises at least one polyurethane, wherein the polyurethane (PU1) is based on the following components:
   11 to 79% by weight of a mixture of at least one diol (D1) and at least one diisocyanate (I1);
   21 to 89% by weight of at least one compound (C1) with two functional groups which are reactive towards isocyanate groups.
11. The process according to embodiment 9 or 10, wherein the at least one diol (D1) is selected from the group consisting of ethane diol, butane diol, hexane diol and monoethylene glycol, preferably comprises at least 1,4-butane diol or monoethylene glycol.
12. The process according to any of embodiments 9 to 11, wherein the at least one isocyanate (I1) is a polyisocyanate, preferably a diisocanyate, more preferably selected from the group consisting of diphenyl methane diisocyanate (MDI), toluenediisocyanate (TDI), hexamethylenediisocyanate (HDI) and dicyclohexyl methane-4,4′-diisocyanate (H12MDI), preferably at least MDI.
13. The process according to any of embodiments 9 to 12, wherein the at least one compound (C1) at least two functional groups which are reactive towards isocyanate groups is a polyol, preferably selected from the group consisting of polyesterpolyol and polyetherpolyol, more preferably at least polytetrahydrofurane.
14. The process according to any of embodiments 9 to 13, wherein the at least one compound (C1) has two functional groups which are reactive towards isocyanate groups, preferably a diol, more preferably selected from the group consisting of polyesterdiol and polyetherdiol, more preferably at least polytetrahydrofurane.
15. The process according to any one of embodiments 9 to 14, wherein the at least one thermoplastic polymer (TP1) comprises at least one polyurethane, wherein the polyurethane (PU1) is based on the following components:
   11 to 79% by weight of a mixture of at least 1,4-butane diol or monoethylene glycol and at least MDI;
   21 to 89% by weight of at least polytetrahydrofuran.
16. The process according to any one of embodiments 1 to 15, wherein the at least one thermoplastic polymer (TP1) comprises at least one polyurethane, wherein the polyurethane (PU1) is based on the following components:
   11 to 79% by weight of a mixture of at least 1,4-butane diol or monoethylene glycol and at least MDI;
   21 to 89% by weight of at least polytetrahydrofuran;
      and the at least one water soluble polymer (WSP1) comprises at least polyvinylpyrrolidone.
17. The process according to any one of embodiments 1 to 16, wherein the at least one TP1 consists of one thermoplastic polymer, preferably of one TPU.
18. The process according to any one of embodiments 1 to 17, wherein the average pore diameter of the porous membrane is in the range of from 0.001 to 2 μm, preferably in the range of from 0.001 μm to 1.5 μm, more preferred in the range of from 0.001 μm to 0.8 μm, determined using Hg porosimetry according to DIN 66133.
19. The process according to any one of embodiments 1 to 18, wherein the porous membrane has an absolute water vapor permeability (WDD_{abs}.) at 38° C. and 90% relative humidity according to DIN 53122 >900 [g/m²*d].
20. The process according to any one of embodiments 1 to 19, wherein the porous membrane has a liquid entry pressure (LEP) >2 bar, preferably in the range of from 2 to 6 bar, more preferably in the range of from 4 to 5 bar, determined according to DIN EN 20811.
21. The process according to any one of embodiments 1 to 20, wherein (i) comprises
   (i.1) compounding at least one thermoplastic polymer (TP1) and at least one water soluble polymer (WSP1) at a temperature above the melting temperature of the at least one thermoplastic polymer;
   (i.2) forming a film from the compound obtained according to (i.1) obtaining a film shaped compound.
22. The process according to embodiment 21, wherein the film forming according to (i.2) is carried out by extrusion.
23. The process according to any one of embodiments 1 to 22, further comprising:
   (iii) drying the porous membrane obtained in (ii).
24. The process according to any one of embodiments 1 to 23, wherein the porous membrane has an average thickness in the range of from 5 to 500 μm, preferably in the range of from 30 to 400 μm.
25. The process according to any one of embodiments 1 to 23, wherein the porous membrane has a minimum thickness of 20 μm and a maximum thickness of 1000 μm, preferably a minimum thickness of 30 μm and a maxmimum thickness of 500 μm, more preferably a minimum thickness of 50 μm and a maximum thickness of 400 μm.
26. Porous membrane comprising a thermoplastic polymer having pores with an average pore diameter <2000 nm, determined using Hg porosimetry according to DIN 66133, obtained or obtainable by a process according to any one of embodiments 1 to 25.
27. Porous membrane comprising a thermoplastic polymer having pores with an average pore diameter <2000 nm, determined using Hg porosimetry according to DIN 66133.
28. Porous membrane according to embodiment 27, wherein the at least one thermoplastic polymer (TP1) is selected from the group consisting of polyurethane, polyester, polyetherester, polyesterester, polyamide, polyetheramide, polystyrene and ethylene vinylacetate, preferably polyurethane (TPU).
29. Porous membrane according to embodiment 27 or 28, wherein the at least one thermoplastic polymer (TP1) comprises at least one polyurethane, wherein the polyurethane (PU1) is based on the following components:
   11 to 79% by weight of a mixture of at least one diol (D1) and at least one polyisocyanate (I1);
   21 to 89% by weight of at least one compound (C1) with at least two functional groups which are reactive towards isocyanate groups.
30. Porous membrane according to any of embodiments 27 to 29, wherein the at least one thermoplastic polymer (TP1) comprises at least one polyurethane, wherein the polyurethane (PU1) is based on the following components:
   11 to 79% by weight of a mixture of at least one diol (D1) and at least one diisocyanate (I1);
   21 to 89% by weight of at least one compound (C1) with two functional groups which are reactive towards isocyanate groups.
31. Porous membrane according to any one of embodiments 27 to30, wherein the at least one diol (D1) is selected from the group consisting of ethane diol, butane diol, hexane diol and monoethylene glycol, preferably comprises at least 1,4-butane diol or monoethylene glycol.
32. Porous membrane according to any one of embodiments 27 to 31, wherein the at least one isocyanate (I1) is a polyisocyanate, preferably a diisocyanate, more preferably selected from the group consisting of diphenyl methane diisocyanate (MDI), toluenediisocyanate (TDI), hexamethylenediisocyanate (HDI) and dicyclohexyl methane-4,4′-diisocyanate (H12MDI), preferably at least MDI.
33. Porous membrane according to any one of embodiments 27 to 32, wherein the at least one compound (C1) at least two functional groups which are reactive towards isocyanate groups is a polyol, preferably selected from the group consisting of polyesterpolyol and polyetherpolyol, more preferably at least polytetrahydrofuran.
34. Porous membrane according to any one of embodiments 27 to 33, wherein the at least one compound (C1) has two functional groups which are reactive towards isocyanate groups, preferably a diol, more preferably selected from the group consisting of polyesterdiol and polyetherdiol, more preferably at least polytetrahydrofurane.
35. Porous membrane according to any one of embodiments 27 to 34, wherein the at least one thermoplastic polymer (TP1) comprises at least one polyurethane, wherein the polyurethane (PU1) is based on the following components:
   11 to 79% by weight of a mixture of at least 1,4-butane diol or monoethylene glycol and at least MDI;
   21 to 89% by weight of at least polytetrahydrofuran.
36. Porous membrane according to any one of embodiments 27 to 35, wherein the at least one TP1 consists of one thermoplastic polymer, preferably of one TPU.
37. Porous membrane according to any one of embodiments 27 to 36, wherein the average pore diameter is in the range of from 0.001 to 2 μm, preferably in the range of from 0.001 μm to 1.5 μm, more preferably in the range of from 0.001 μm to 0.8 μm, determined using Hg porosimetry according to DIN 66133.
38. Porous membrane according to any one of embodiments 27 to 37 wherein the porous membrane has an absolute water vapor permeability (WDD_{abs}.) at 38° C. and 90% relative humidity according to DIN 53122 >900 [g/m²*d].
39. Porous membrane according to any one of embodiments 27 to 38, wherein the porous membrane has a liquid entry pressure (LEP) >2 bar, preferably in the range of from 2 to 6 bar, more preferably in the range of from 4 to 5 bar, determined according to DIN EN 20811.
40. Porous membrane according to any one of embodiments 27 to 39, wherein the porous membrane has an average thickness in the range of from 5 to 500 μm, preferably in the range of from 30 to 400 μm.
41. Porous membrane according to any one of embodiments 27 to 40, wherein the porous membrane has a minimum thickness of 20 μm and a maximum thickness of 1000 μm, preferably a minimum thickness of 30 μm and a maximum thickness of 500 μm, more preferably a minimum thickness of 50 μm and a maximum thickness of 400 μm.
42. Use of the porous membrane obtained or obtainable according to the process of any one of embodiments 1 to 25 or of the porous membrane according to embodiment 26 or of the porous membrane according to any one of embodiments 27 to 41 for coating a woven surface of an article.
43. Use of the porous membrane obtained or obtainable according to the process of any one of embodiments 1 to 25 or of the porous membrane according to embodiment 26 or of the porous membrane according to any one of embodiments 27 to 41 for an article having no woven layer.
44. Use of the porous membrane according to embodiment 42 or 43, wherein the article is selected from the group of functional clothing, functional foot wear and functional article, preferably selected from the group consisting of jacket, trouser, shoe, boot, protective suit, tent, tarpaulin, backpack and umbrella.
45. Article comprising the porous membrane obtained or obtainable according to the process of any one of embodiments 1 to 25 or of the porous membrane according to embodiment 26 or of the porous membrane according to any one of embodiments 27 to 41.

### Cited Literature

U.S. Pat. No. 3,962,153

U.S. Pat. No. 3,953,566

“Kunststoffhandbuch, volume 7, Polyurethane”, Carl Hanser Verlag, 3rd edition 1993, section 3.1

Kunststoffhandbuch, volume 7, Polyurethane”, Carl Hanser Verlag, 1st edition 1966, pp. 103-113

The present invention is further illustrated by the following reference examples, comparative examples, and examples.

### EXAMPLES

1. Measurement Methods
Water vapor permeability (WDD): DIN 53122 at 38° C. and 90% humidity
Liquid entry pressure (LEP): DIN 20811

2. Materials

2.1 Chemicals

| Abbreviation | Name/function | Chemical composition |
|---|---|---|
| Iso1 | Isocyanate 1 | 4,4′-diphenylmethane diisocyanate |
| Poly1 | Polyol 1 | Polytetrahydrofurane, |
| | | Mn¹): ~1000 g/mol, |
| | | OH number 112 |
| KV1 | Chain extender 1 | 1,4-Butane diol |
| Stab1 | Stabilisator 1 | sterically hindered Phenole |
| | (antioxidant) | |
| Wax1 | lubricant 1 | Bisstearylamide |

¹)Mn: number average molecular weight

2.2 Polymers

| Abbreviation | Chemical compound |
|---|---|
| Polymer 1 | polyether-based thermoplastic polyurethane, hardness 85 Shore A |
| Polymer 2 | polyethylene oxide, Mn: 300,000 g/mol |
| Polymer 3 | Polyvinylpyrolidone, Mn: 1,400 kg/mol, powder (particle size distribution: |
| | D₁₀ < 90 μm, D₅₀ < 180 μm, D₉₀ < 350 μm) |
| Polymer 4 | Polyvinylpyrolidone, Mn: 50 kg/mol, powder (particle size distribution: |
| | D₁₀ < 90 μm, D₅₀ < 180 μm, D₉₀ < 350 μm) |

Mn: number average molecular weight
D10, D50, D90: represents the particle diameter corresponding to cumulative (from 0 to 100%) undersize particle size distribution, i.e. 10% of the particles in the tested sample are smaller than 90 μm, 50% are smaller than 180 μm and 90 of the particles in the tested sample are smaller than 350 μm.

2.3 Preparation of Polymer 1
61.22% by weight Polyol 1 were mixed with 5.94% by weight of KV1 under stirring. After heating to 80° C., 31.84% by weight of Iso1 was added, together with 1% by weight Stab1 and 0.05% by weight of wax1. The solution was stirred until homgenous. The mixture heated up and was then poured onto a heated, teflon coated table. The slab was tempered for 12h at 110° C. and granulated afterwards.
Extrusion
Polymer 1 was processed on a twin-screw extruder to cylinder shaped granules for homogenization. The extrusion was carried out on a twin-screw extruder having 19 mm screw diameter, resulting in a strand diameter of about 2 mm. The temperature profile is indicated in Table 1.

TABLE 1

| Extruder: | Co-rotating twin screw extruder, APV MP19 |
|---|---|
| temperature profile: | HZ1 170° C. to 220° C. |
| | HZ2 180° C. to 230° C. |
| | HZ3 190° C. to 230° C. |
| | HZ4 210° C., to 240° C. |
| | HZ5 (nozzle) 200° C. to 240° C. |
| Screw speed: | 100 U/min |
| pressure: | about 10 to 30 bar |
| Strand cooling: | Water bath (10° C.) |

HZ: heating zone

The temperature profile was chosen depending on the softening temperature oft he polymer.

3. Membrane Preparation

3.1 Compounding
Materials were compounded according to the compositions mentioned in Table 2 using a Coperion ZSK-18MC twin screw extruder. The extruder was equipped with a pair of 18 mm diameter, L/D=40 co-rotating, intermeshing screws, held in 10 barrels, and a separate feeder for each component. The melt temperature was 205° C. The die was heated and equipped with two 3 mm diameter nozzles. The extruded strand was passed through a water bath, then a pelletizer.

TABLE 2
composition of the materials compounded

| | Mem- | Mem- | Mem- | Mem- | Mem- | Mem- |
|---|---|---|---|---|---|---|
| | brane 1 | brane 2 | brane 3 | brane 4 | brane 5 | brane 6 |
| | [% by | [% by | [% by | [% by | [% by | [% by |
| | weight] | weight] | weight] | weight] | weight] | weight] |
| Polymer 1 | 100 | 90 | 70 | 70 | 79 | 80 |
| Polymer 2 | 0 | 0 | 0 | 0 | 21 | 0 |
| Polymer 3 | 0 | 10 | 30 | 0 | 0 | 20 |
| Polymer 4 | 0 | 0 | 0 | 30 | 0 | 0 |

3.2 Film Extrusion
Blown films were prepared from the compounded pellets according to section 3.1 using a Killion 40 mm single screw extruder and blown film die. Melt temperature was 220° C. The film thickness varied from 75 to 400 microns.

3.3 Extraction/Pore Formation
The films according to section 3.2 were cut into squares, 18×18 cm, weighed and soaked in deionized water (3 films in 1 liter water) at room temperature for 24 hours in order to remove the water-soluble polymer (Polymer 2, Polymer 3). The membrane squares were dried in a vacuum oven at 50° C. for 14 hours and re-weighed.

4. Analysis of membrane properties before and after extraction
Liquid entry pressure (LEP) and water vapor permeability (WDD absolute and relative (1 mm)) were measured for the films according to section 3.2; for the film squares obtained in section 3.3, WDD and weight loss were determined. The results are shown in Table 3.

TABLE 3
LEP and WDD data of membranes 1 to 6 before and after extraction with water

| | Membrane 1 | | | | | |
|---|---|---|---|---|---|---|
| | (comparative) | | Membrane 2 | | Membrane 3 | |
| | Before | After | Before | After | Before | After |
| | extraction | extraction | extraction | extraction | extraction | extraction |
| Film thickness [μm] | 120 | 120 | 120 | 120 | 330 | 320 |
| LEP [bar] | >4 | 4 | 4 | 3 | 4 | 3 |
| WDD [g/m² d] | 275 | 284 | 330 | 1255 | 355 | 1124 |
| WDD_{1 mm} [g/m² d] | 34 | 34 | 40 | 150 | 128 | 354 |
| | Membrane 4 | | Membrane 5 | | Membrane 6 | |
| | Before | After | Before | After | Before | After |
| | extraction | extraction | extraction | extraction | extraction | extraction |
| Film thickness [μm] | 120 | 120 | 60 | 60 | 125 | 130 |
| LEP [bar] | >4 | >2 | >4 | >2 | 4 | >2 |
| WDD [g/m² d] | 340 | 1292 | 705 | 1830 | 290 | 1040 |
| WDD_{1 mm} [g/m² d] | 41 | 155 | 42 | 110 | 36 | 135 |

The results indicate that water vapor permeability significantly improves after extraction of the soluble polymer, i.e. that the porous membranes according to the invention have improved water vapor permeability.

6. Pore Size of the Membranes
The average pore size of each membrane obtained according to Table 3 was determined based on REM pictures to be about 1 μm.

1. A process for preparing a porous membrane comprising a thermoplastic polymer, the process comprising:
(i) forming a film shaped compound comprising the thermoplastic polymer and a water soluble polymer; and
(ii) extracting the film shaped compound with a solvent mixture, thereby obtaining the porous membrane;
wherein the thermoplastic polymer has pores with an average pore diameter <2000 nm. determined using Hg porosimetry according to DIN 66133,
the thermoplastic polymer comprises a polyurethane,
wherein the polyurethane comprises:
from 11 to 79% by weight of a mixture comprising a diol and a diisocyanate; and
from 21 to 89% by weight of a compound with two functional groups which are reactive towards isocyanate groups.

2. The process according to claim 1, wherein the water-soluble polymer has a solubility in water of >50 g/l.

3. The process according to claim 1, wherein the water soluble polymer is at least one selected from the group consisting of polyethylene oxide and polyvinylpyrrolidone.

4. The process according to claim 1, wherein the mixture comprises water.

5. The process according to claim 1, wherein the extracting is carried out for at least 1 hour.

6. The process according to claim 1, wherein the extracting is carried out at a temperature in the range of from 5 to 100° C.

7. The process according to claim 1, wherein the thermoplastic polymer is selected from the group consisting of polyurethane, polyester, polyetherester, polyesterester, polyamide, polyetheramide, polystyrene and ethylene vinylacetate.

8. A porous membrane, comprising a thermoplastic polymer having pores with an average pore diameter <2000 nm, determined using Hg porosimetry according to DIN 66133, obtained by the process according to claim 1.

9. A porous membrane, comprising:
a thermoplastic polymer having pores with an average pore diameter <2000 nm, determined using Hg porosimetry according to DIN 66133;
wherein the thermoplastic polymer comprises polyurethane, wherein the polyurethane comprises:
from 11 to 79% by weight of a mixture comprises a diol and a diisocyanate (I1); and
from 21 to 89% by weight of a compound with two functional groups which are reactive towards isocyanate groups.

10. A process for coating a woven surface of an article, the process comprising:
coating the article with the porous membrane obtained by the process of claim 1,
wherein the article is selected from the group consisting of a functional clothing, a functional foot wear and a functional article.

11. An article having no woven layer, wherein the article comprises the porous membrane obtained by the process of claim 1, and
the article is selected from the group consisting of a functional clothing, a functional foot wear and a functional article.

12. An article, comprising the porous membrane obtained by the process of claim 1.
